(19) United States
(12) Patent Application Publication
(10) Pub. No.: US 2010/0249968 A1
(43) Pub. Date: Sep. 30, 2010

(54) FACTORY RESOURCE OPTIMIZATION IDENTIFICATION PROCESS AND SYSTEM

(76) Inventors: Andreas Neuber, Stuttgart (DE); Parth Sethia, Sunnyvale, CA (US); Parris C.M. Hawkins, Los Altos, CA (US); Krishna Vepa, Santa Clara, CA (US); Raymond Murray, Dublin (IE)

Correspondence Address: APPLIED MATERIALS/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/730,969

(22) Filed: Mar. 24, 2010

Related U.S. Application Data
(60) Provisional application No. 61/163,426, filed on Mar. 25, 2009.

(51) Int. Cl. G06F 19/00; G06F 3/048

(52) U.S. Cl. 700/99; 700/108; 715/772

(57) ABSTRACT

A method and system for factory resource optimization identification is described herein. In one embodiment, an expected usage rate is determined for a resource in a manufacturing facility and an actual usage rate is determined for the resource in the manufacturing facility. A comparison between the expected usage rate and the actual usage rate is facilitated. A determination is made, based on the comparison, of whether a variance between the expected usage rate and the actual usage rate exceeds a threshold. A notification is provided if the variance exceeds the threshold.

### PRIORITY CLAIM

This application claims the benefit of U.S. Provisional Application Ser. No. 61/163,426 filed Mar. 25, 2009, which is hereby incorporated by reference.

### TECHNICAL FIELD

Embodiments of the present invention relate to factory optimization, and more specifically to identifying resources that warrant further optimization analysis.

### BACKGROUND OF THE INVENTION

Nanomanufacturing factories purchase and make extensive use of input resources such as spare equipment parts, process chemicals, gases, energy or any other consumable (i.e., anything consumed by a factory in manufacturing a product). For example, a typical 300 mm wafer manufacturing factory consumes millions of dollars a year in input resources. Input resources are consumed by process tools, sub-fabrication systems, such as abatement, and fabrication-wide systems, such as lighting and air conditioning. The input resource purchases may be made without an understanding of where and how these input resources are being used in manufacturing the product. A factory may not be operating optimally and may be generating waste. As a result, a manufacturer may be overspending when purchasing resources as well as wasting precious natural resources and adding to increased global warming.

### BRIEF DESCRIPTION OF THE DRAWINGS

The present invention is illustrated by way of example, and not by way of limitation, in the figures of the accompanying drawings and in which:

FIG. 1A illustrates an exemplary network architecture on which embodiments of the present invention may be implemented;

FIG. 1B illustrates another exemplary network architecture on which embodiments of the present invention may be implemented;

FIG. 2 illustrates an embodiment of a resource optimization identification system;

FIG. 3A illustrates one embodiment of a method for identifying resources for optimization;

FIG. 3B illustrates another embodiment of a method for identifying resources for optimization;

FIG. 4 illustrates an exemplary graphical user interface (GUI) to present expected usage rates and actual usage rates for a factory's resources, in accordance with one embodiment of the invention;

FIGS. 5A, 5B and 5C illustrate exemplary GUIs to further enable optimization analysis for a resource; and

FIG. 6 illustrates an exemplary computer system.

### DETAILED DESCRIPTION

Embodiments of the invention are directed to a method and system for identifying factory resources for optimization. A resource optimization identification system determines a factory's expected usage rate for a resource and the factory's actual usage rate for the resource. The resource optimization identification system identifies a deviation between the expected usage rate and the actual usage rate. In particular, the resource optimization identification system identifies whether the actual usage rate is greater than the expected usage rate. The resource optimization identification system compares the deviation to a threshold and sends a notification identifying the factory resource for further optimization analysis if the deviation is greater than the threshold. The resource optimization identification system can provide a user interface to illustrate a comparison of the factory's expected usage rate for a resource to the factory's actual usage rate for the resource and provide a visual indicator in the user interface indicating a resource may warrant further optimization analysis. Further, a resource can be identified for further optimization analysis, and information can be provided than can be used to set baselines, thresholds, benchmarks, operating limits, and set points for a factory, enabling a user to reduce expenses when purchasing resources and to reduce the amount of waste produced by a factory.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “identifying”, “comparing”, “sending”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relates to an apparatus for performing the operations herein. This apparatus can be specially constructed for the required purposes, or it can comprise a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems can be used with programs in accordance with the teachings herein, or it may prove convenient to construct a more specialized apparatus to perform the method steps. The structure for a variety of these systems will appear from the description below. In addition, embodiments of the present invention are not described with reference to any particular programming language. It will be appreciated that a variety of programming languages can be used to implement the teachings of the invention as described herein.

A machine-readable storage medium can include any mechanism for storing information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only memory (EPROM), Electrically Erasable Programmable Read-Only Memory (EEPROM), magnetic or optical cards, flash memory, or the like.

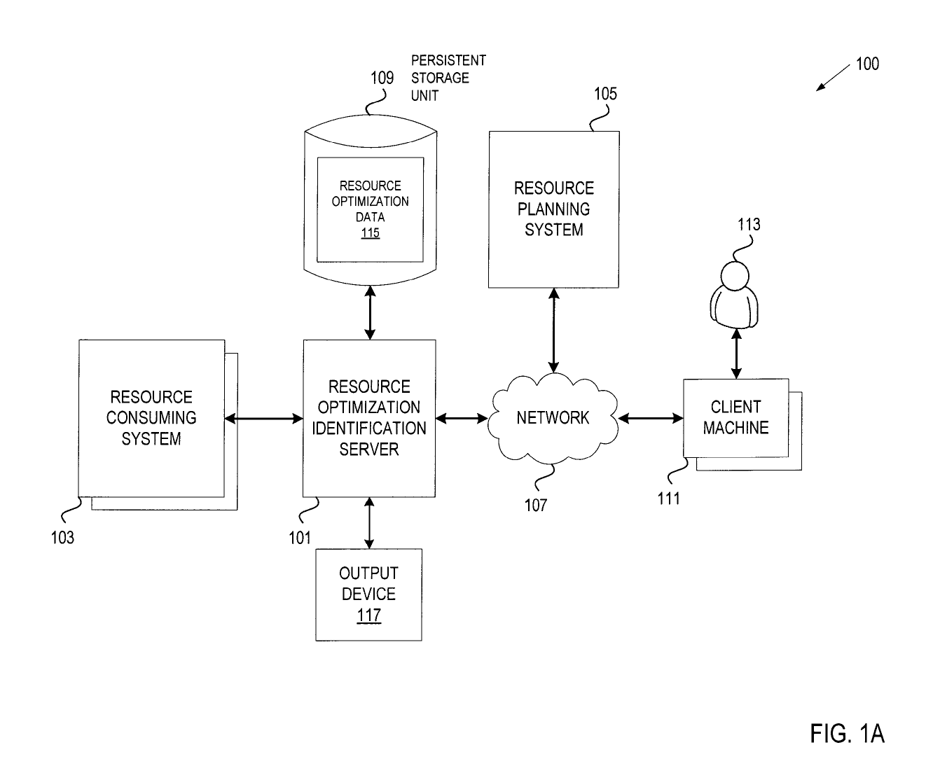

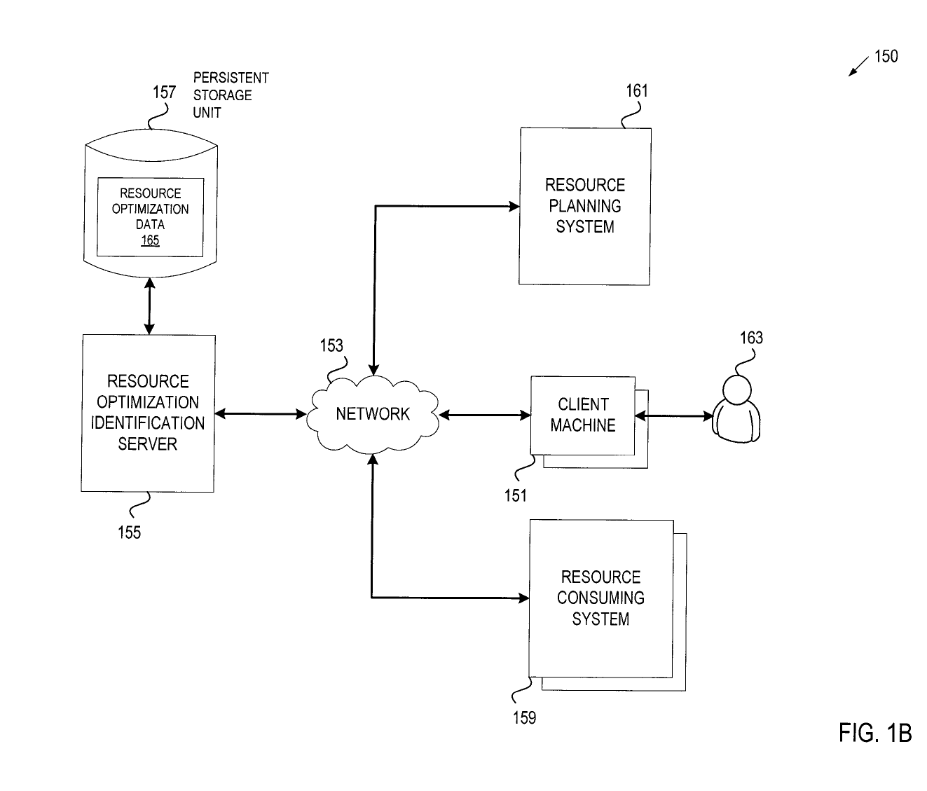

FIG. 1A illustrates an exemplary network architecture 100 on which embodiments of the present invention can be implemented. In one embodiment, a resource optimization identification apparatus can be a server 101 residing in a factory coupled locally to one or more resource consuming systems 103, and to a resource planning system 105 over a network 107. The resource optimization identification server 101, resource consuming systems 103, and resource planning system 105 can be maintained by a factory administrator. The resource optimization identification server 101 can be hosted by any type of computing device including desktop computers, laptop computers, handheld computers or similar computing device. Resource consuming systems 103 can include manufacturing tools and factory systems, and can include any type of computing device, including desktop computers, laptop computers, handheld computers or similar computing device, to exchange data with resource optimization identification server 101. Examples of manufacturing tools include tools for the manufacture of electronic devices (e.g., etchers, chemical vapor deposition furnaces, etc.) or of a type for manufacturing other products. Examples of factory systems include abatement systems, air conditioning, systems consuming DI water (deionized water, distilled water), bulk nitrogen, etc. The resource planning system 105 can be hosted by any type of computing device including desktop computers, laptop computers, handheld computers or similar computing device.

The resource optimization identification server 101 can connect to the resource consuming systems 103 directly, indirectly via a hardware interface (not shown), or via a network (not shown). The resource optimization identification server 101 can connect to the resource planning system 105 via a network 107. The network 107 can be a local area network (LAN), such as an intranet within a company, a wireless network, a mobile communications network, a wide area network (WAN), such as the Internet or similar communication system. The network 107 can include any number of networking and computing devices such as wired and wireless devices.

A factory (e.g., a factory in the semiconductor, PV, display, MEMS, nanomanufacturing, glass, web, etc. industries) purchases and makes extensive use of input resources. Resources can be consumed by manufacturing tools (process tools), sub-fabrication systems, such as abatement, and fabrication-wide systems, such as lighting and air conditioning. Examples of input resources (resources) include spare equipment parts, process chemicals, gases, energy or any consumable (i.e., anything consumed by a factory in manufacturing a product). The resource optimization identification server 101 can collect resource optimization data 115 from the resource consuming systems 103 (e.g., manufacturing tools, factory systems) and resource planning system 105. The resource optimization data 115 can include factory data collected from the resource consuming systems 103 and resource planning data collected from the resource planning system 105. The resource optimization identification server 101 can store the resource optimization data 115 in a persistent storage unit 109. The persistent storage unit 109 can be a local storage unit or a remote storage unit. The persistent storage unit 109 can be a magnetic storage unit, optical storage unit, solid state storage unit or similar storage unit. The persistent storage unit 109 can be a monolithic device or a distributed set of devices. A ‘set,’ as used herein, refers to any positive whole number of items including one.

The resource optimization identification server 101 can connect to one or more client machines 111 via network 107. The client machines 111 can be any type of computing device including desktop computers, laptop computers, mobile communications devices, cell phones, smart phones, handheld computers or similar computing device. The resource optimization identification server 101 can output resource optimization data 115 to one or more client machines 111 accessible by one or more users 113. For example, the resource optimization identification server 101 can generate graphical user interfaces (GUIs) to display the resource optimization data 115 accessible by one or more client machines 111. The resource optimization identification server 101 can also send an email message and/or text message regarding the resource optimization data 115 to client machines 111 accessible by users 113. The resource optimization identification server 101 can also output resource optimization data 115 to an output device 117 (e.g., display unit, printer) coupled to the resource optimization identification server 101.

FIG. 1B illustrates an exemplary network architecture 150 on which embodiments of the present invention may be implemented. This example uses client-server architecture. One or more client machines 151 can communicate over network 153 with a central server, such as resource optimization identification server 155, to access resource optimization data 165 stored on persistent storage unit 157. The client machines 151 can be hosted by any type of computing device including desktop computers, laptop computers, mobile communications devices, cell phones, smart phones, handheld computers or similar computing device. The resource optimization identification server 155 can be hosted by any type of computing device including desktop computers, laptop computers, handheld computers or similar computing device. The network 153 can be a local area network (LAN), such as an intranet within a company, a wireless network, a mobile communications network, or a wide area network (WAN), such as the Internet or similar communication system. The network 153 can include any number of networking and computing devices such as wired and wireless devices.

In one embodiment, the resource optimization identification server 155 can communicate over network 153 with the resource consuming systems 159 (e.g., one or more manufacturing tools, components of manufacturing tools, factory systems) and the resource planning system 161 to collect resource optimization data 165. The resource optimization identification server 155 can store the resource optimization data 165 in a persistent storage unit 157.

The resource optimization identification server 155 can generate GUIs to display the resource optimization data 165. One or more client machines 151 can connect to the resource optimization server 155 over network 153 and can render the GUIs via a browser (not shown). The resource optimization identification server 155 can also generate notifications (e.g., email messages, text messages) and send the notifications over network 153 to one or more client machines 151 accessible by users 163.

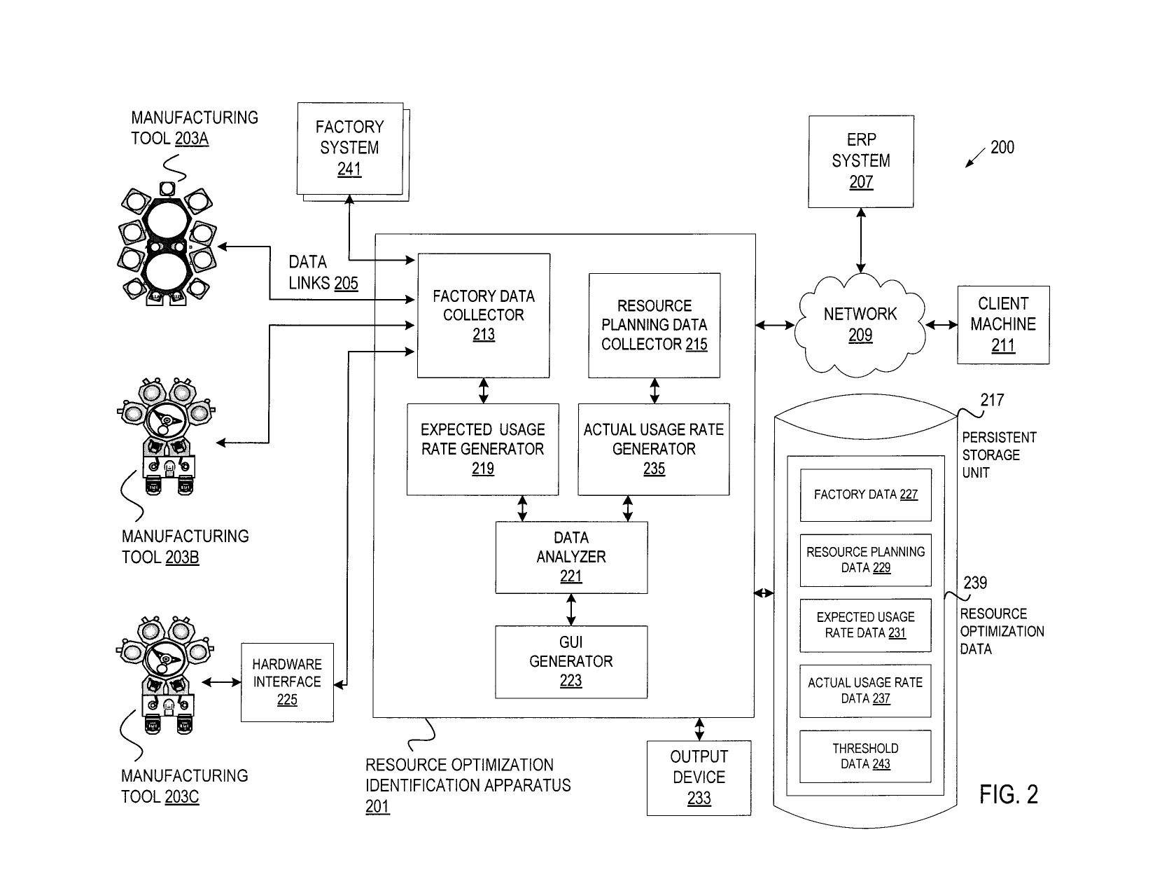

FIG. 2 illustrates one embodiment of a resource optimization identification system 200 for identifying factory resources for optimization. In one embodiment, the resource optimization identification system 200 is used in the manufacturing of electronic devices. The electronic devices can be manufactured in a factory using nano manufacturing technology and can include, for example, the manufacture of semiconductors, solar, display, LED, etc. Manufacturing such devices generally includes dozens of manufacturing steps involving different types of manufacturing processes and resources. Alternatively, the resource optimization identification system 200 can be used to monitor the manufacture of other products (e.g., automobiles), which may also include many different processing steps by various manufacturing tools using many different resources.

The resource optimization identification system 200 can include a resource optimization identification apparatus 201, resource consuming systems (e.g., one or more manufacturing tools 203A,B,C or one or more factory systems 241), an enterprise resource planning (ERP) system 207, and a persistent storage unit 217. The resource optimization identification apparatus 201 can be hosted by any type of computing device including desktop computers, laptop computers, handheld computers or similar computing device. In one embodiment, the resource optimization identification apparatus 201 can be a server (e.g., resource optimization identification server 101 in FIG. 1A) coupled to manufacturing tools 203A,B,C and one or more factory systems 241. In another embodiment, the resource optimization identification apparatus 201 can be a client machine. The resource optimization identification apparatus 201 can connect directly to manufacturing tools 203A,B,C by data communication links 205 (e.g., EDI direct connection links), via a network (not shown), via a hardware interface 225, or a combination thereof. The resource optimization identification apparatus 201 can also connect directly to one or more factory systems 241 by data communication links 205, via a network (not shown), via a hardware interface 225, or a combination thereof. The resource optimization identification apparatus 201 can connect to a system 207 designed to coordinate all of a factory's resources, information, and activities (e.g., an Enterprise Resource Planning (ERP) system) via a network 209. The ERP system 207 can be hosted by any type of computing device including desktop computers, laptop computers, handheld computers or similar computing device. The network 209 can be a local area network (LAN), such as an intranet within a company, a wireless network, a mobile communications network, a wide area network (WAN), such as the Internet or similar communication system. The network 209 can include any number of networking and computing devices such as wired and wireless devices.

The resource optimization identification system 200 can include all manufacturing tools 203A,B,C in a factory or only some manufacturing tools 203A,B,C in the factory. Each of the manufacturing tools 203A,B,C can be a tool for the manufacture of electronic devices (e.g., etchers, chemical vapor deposition furnaces, etc.) or of a type for manufacturing other products. Examples of manufacturing tools 203A,B,C include process tools for manufacturing 300 mm and 200 mm wafer technology. Each manufacturing tool 203A,B,C (process tools) can include multiple sensors (not shown) for monitoring processes run on the manufacturing tool 203A,B,C. Examples of types of sensors include flow meters, temperature sensors, pressure sensors, or any other sensors that monitor physical conditions of a manufacturing process or physical properties of a work piece manufactured by the manufacturing tools 203A,B,C.

The resource optimization identification system 200 can include all factory systems 241 in a factory or only some factory systems 241 in the factory. Factory systems 241 can include factory-wide systems (e.g., lighting, air conditioning), sub-factory systems (e.g., abatement systems), and systems consuming distilled and/or deionized water, bulk nitrogen, etc.

The resource optimization identification apparatus 201 can include a factory data collector 213, a resource planning data collector 215, an expected usage rate generator 219, an actual usage rate generator 235, a data analyzer 221, and a GUI generator 223. This division of functionality is presented by way example for sake of clarity. One skilled in the art would understand that the functionality described could be combined into a monolithic component or sub-divided into any combination of components. Factory data collector 213, resource planning data collector 215, expected usage rate generator 219, actual usage rate generator 235, data analyzer 221 and GUI generator 223 can be hosted on a single computer system, on separate computer systems, or on a combination thereof.

The factory data collector 213 can collect factory data 227 from manufacturing tools 203A,B,C and one or more factory systems 241 to determine the expected usage rate for a resource (e.g., process chemicals, gases, energy) for a factory. The factory data collector 213 can collect factory data 227 by tracking sensors (not shown) on the manufacturing tools 203A,B,C using the resource. Examples of the types of factory data 227 collected include factory data for an individual process tool, for a component of a process tool, for a particular process, for a particular process recipe, for when a process tool is idle or being cleaned, for a resource used by a factory-wide system and for a resource used by a sub-factory system. For example, the factory data collector 213 can collect data from the factory systems 241 and the sensors of any manufacturing tools 203A,B,C using the chemical ammonia in a process. System 200 can store the factory data 227 in a persistent storage unit 217.

The expected usage rate generator 219 can use the factory data 227 to generate the expected usage rate for factory using a resource. For example, the expected usage rate generator 219 can use the factory data 227 collected from the one or more manufacturing tools 203A,B,C or factory systems 241 using ammonia in one or more processes to determine the expected amount of ammonia to be used by the factory.

The resource planning data collector 215 can collect resource planning data 229 from a system 207 to determine an actual usage rate for a resource in a factory. System 207 is a system designed to coordinate all of a factory's resources, information, and activities (e.g., ERP system). For example, the resource planning data collector 215 can obtain from the ERP system 207 the amount of ammonia purchased for a factory. System 200 can store the resource planning data 229 in persistent storage unit 217.

The actual usage rate generator 235 can use the resource planning data 229 to generate the actual usage rate for the factory for a particular resource. For example, the actual usage rate generator 235 can determine the amount of ammonia purchased for a factory from the resource planning data 229 and use the amount of ammonia purchased for the factory as the actual usage rate for ammonia for the factory.

The data analyzer 221 compares the expected usage rate data 231 to the actual usage rate data 237. The data analyzer 221 can detect whether a deviation exists between the actual usage rate for a resource and the expected usage rate for the resource. In particular, the data analyzer 221 can detect whether the actual usage rate for a resource is greater the expected usage rate for the resource. For example, the data analyzer 221 can determine whether the actual amount of ammonia used (purchased) for the factory is greater than the amount of ammonia expected to be used by the factory.

The data analyzer 221 can further compare the deviation to a threshold to determine whether a process, a manufacturing tool, and/or factory system using the resource warrants further analysis for optimization. The threshold can be a user-defined threshold, a baseline, a benchmark, a user-defined limit, or a limit generated based on actual data collected over time. The threshold can be stored in persistent storage unit 217 as threshold data 243. For example, the data analyzer 221 may determine that the deviation is less than (or less than or equal to) the threshold and thus, the resource does not warrant further resource optimization analysis. In another example, the data analyzer 221 may determine that the deviation is greater than (or greater than or equal to) the threshold and thus identifies the resource for further resource optimization analysis.

The persistent storage unit 217 can store the resource optimization data 239. The resource optimization data 239 can include the factory data 227, the resource planning data 229, the expected usage rate data 231, the actual usage rate data 237 and the threshold data 243.

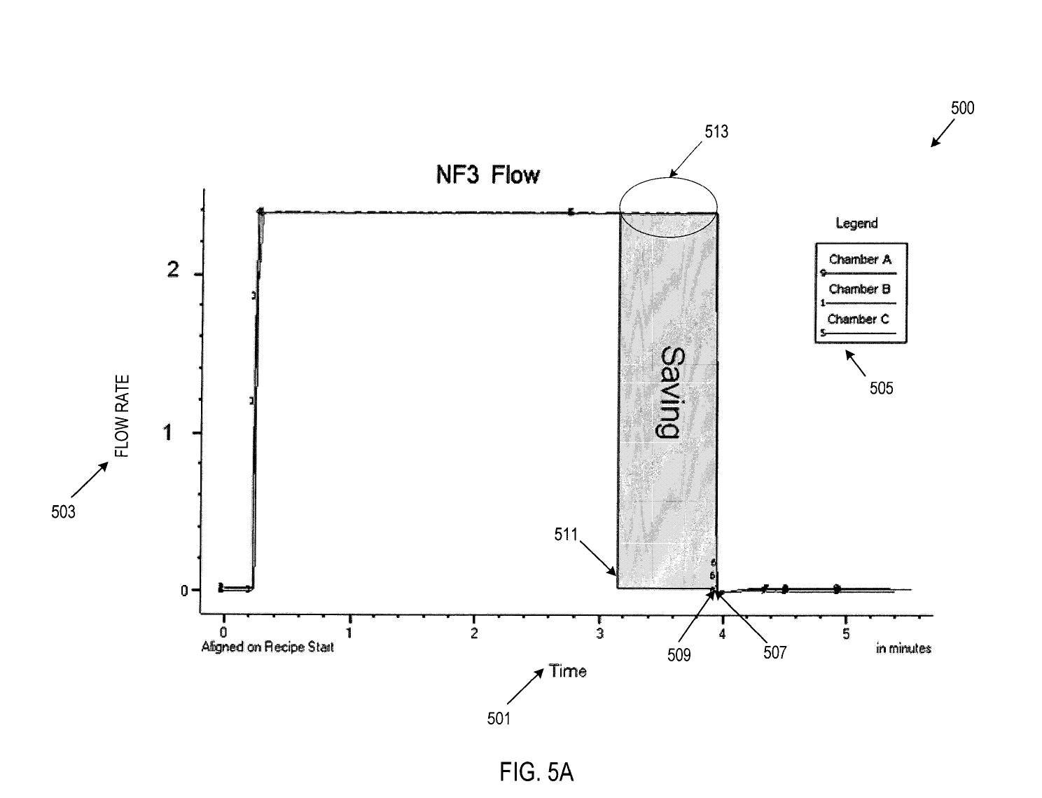

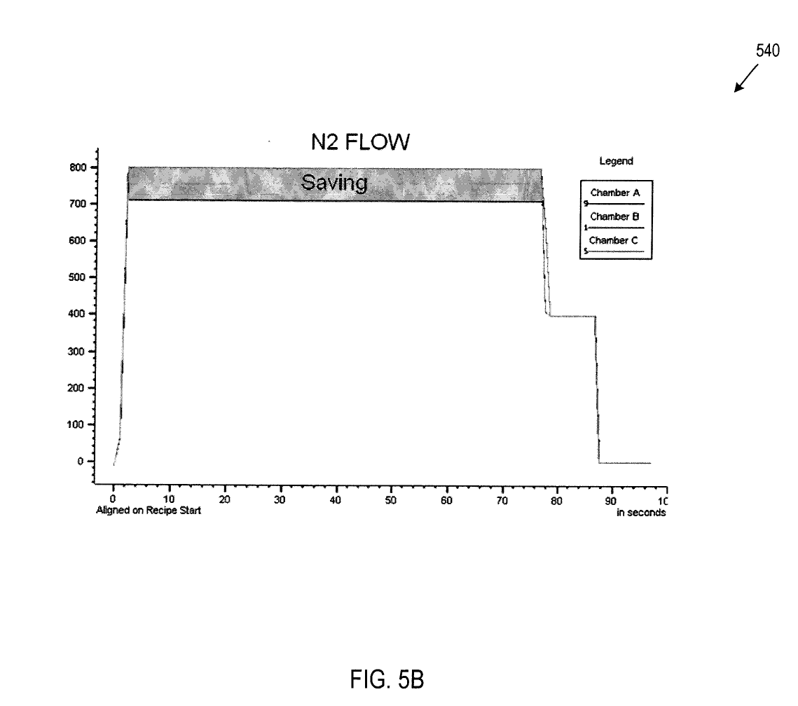

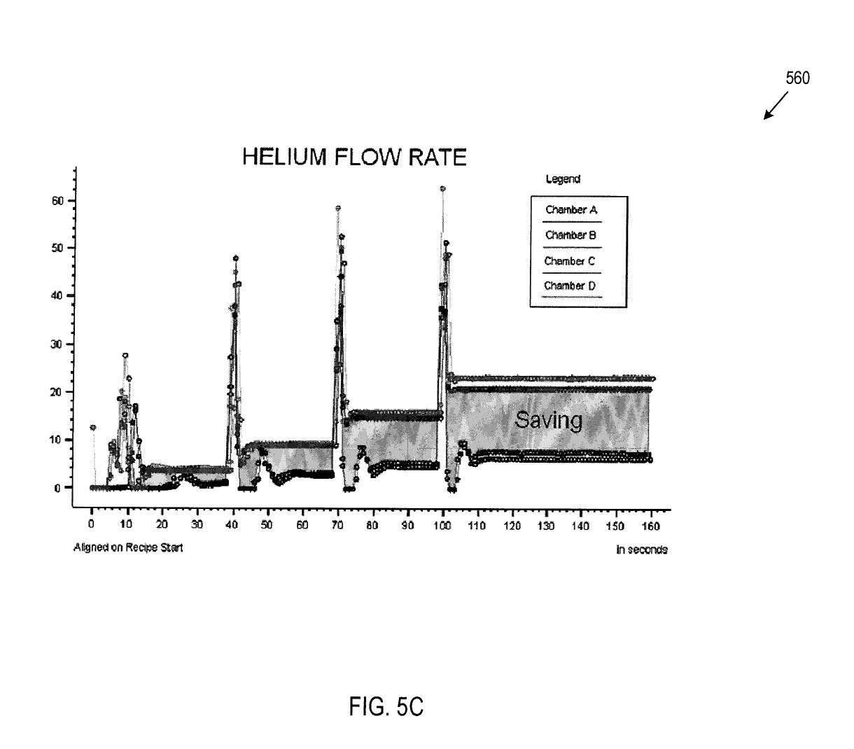

The GUI generator 223 can generate GUIs to illustrate the resource optimization data 239. In particular, the GUI generator 223 can generate GUIs to illustrate a comparison of a factory's expected usage rate data 231 to the factory's actual usage rate data 237 for one or more resources. The GUI generator 223 can generate a GUI to graphically indicate a factory resource that warrants further optimization analysis. The GUI generator 223 can also generate GUIs to illustrate factory data 227 collected from manufacturing tools 203A,B,C and factory systems 241 to enable further resource optimization analysis. FIGS. 5A-5C, described in greater detail below, illustrate exemplary GUIs for enabling further resource optimization analysis. The GUIs generated by GUI generator 223 can be accessible via a browser on a client machine 211, or a GUI generator 223 can reside on a client machine 211 and can receive the resource optimization data 239 from data analyzer 221 via a network. Client machines 211 can be any type of computing device including desktop computers, laptop computers, mobile communications devices, cell phones, smart phones, handheld computers or similar computing device. In one embodiment, the resource optimization identification apparatus 201 includes an output device 233 (e.g., display unit, printer). The resource identification apparatus 201 can output the resource optimization data 239 via the output device 233.

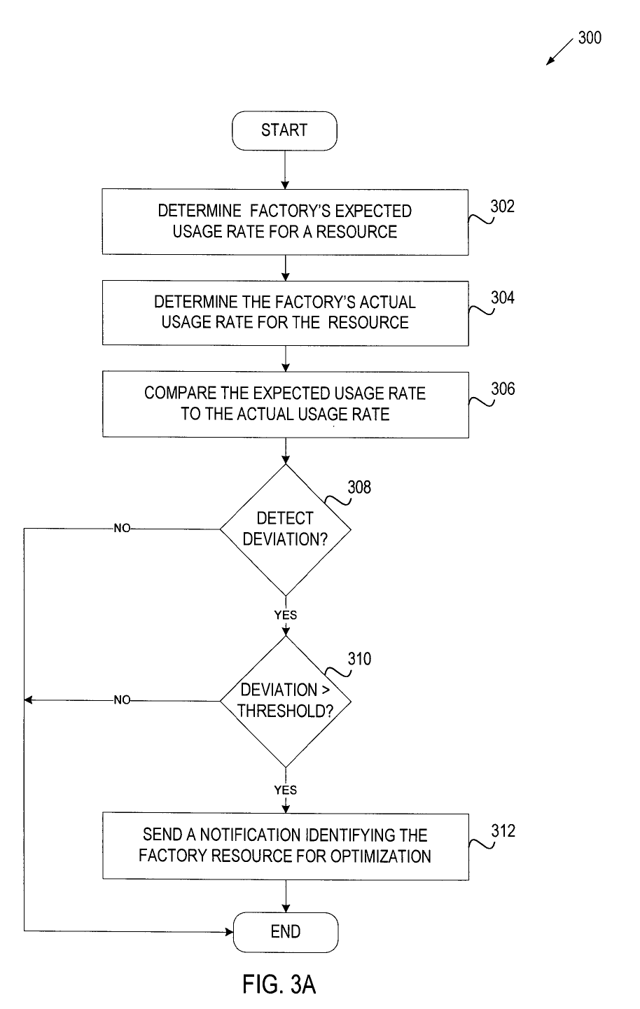

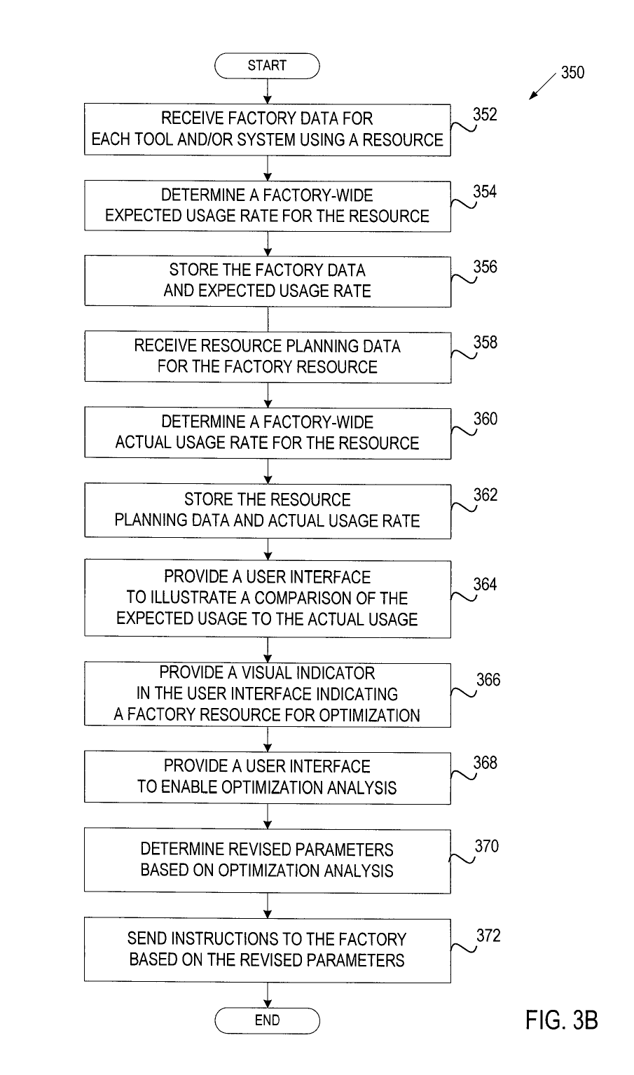

FIG. 3A illustrates one embodiment of a method 300 for identifying resources for optimization. Method 300 can be performed by processing logic that can comprise hardware (e.g., circuitry, dedicated logic, programmable logic, microcode, etc.), software (e.g., instructions run on a processing device), or a combination thereof. In one embodiment, method 300 is performed by the resource optimization identification apparatus 201 of FIG. 2.

At block 302, processing logic determines a factory's expected usage rate for a resource. A resource may be used in one or more factory processes or may be used by one or more manufacturing tools and/or factory systems. For example, in semiconductor manufacturing, the resource chemical ammonia can be used in multiple processes (e.g., cleaning process, photolithographic process) and used by one or more tools (e.g., steppers, step-and-scan machines). Processing logic can determine the expected usage rate for the chemical resource ammonia used in by a factory by collecting and combining the data for the individual processes, individual tools, and individual systems using ammonia. Processing logic can also collect data from the tools in their idle or cleaning state to determine the factory's expected usage rate for a resource (e.g., ammonia).

At block 304, processing logic determines the factory's actual usage rate for the resource. Processing logic can obtain resource planning data for the resource from a resource planning system (e.g., an enterprise planning (ERP) system) to determine the factory's actual usage rate for a resource. For example, processing logic can obtain the amount of ammonia purchased for any processes using ammonia to determine the actual usage rate for ammonia for the factory. At block 306, processing logic compares the factory's expected usage rate for the resource to the factory's actual usage rate for the resource.

At block 308, processing logic determines whether there is a deviation between the expected usage and the actual usage for the resource. In particular, processing logic can determine whether the factory's actual usage rate for a resource is greater than the factory's expected usage rate for a resource. For example, processing logic can determine that the amount of ammonia used (purchased) for the factory processes was greater than the amount of ammonia expected to be used by the factory processes. Processing logic can also detect a deviation where the expected usage rate is less than the actual usage rate. If processing logic does not detect a deviation (block 308), method 300 completes. If processing logic detects a deviation (block 308), processing logic compares the deviation to a threshold at block 310.

At block 310, processing logic compares the deviation to a threshold. The threshold can be a user-defined threshold, a baseline, a benchmark, a user-defined limit, or a limit generated based on actual data collected over time. Processing logic can use the threshold to determine the extent of the deviation. A resource having a deviation that is greater than (or greater than or equal to) the threshold may be a resource that warrants further optimization analysis. A resource having a deviation that is less than (or less than or equal to) the threshold may be a resource that does not warrant further optimization analysis. For example, processing logic may determine that the actual usage rate of ammonia used in multiple processes (e.g., cleaning process, photolithographic process, etc.) in the factory was slightly greater than the expected usage rate of ammonia to be used in the multiple processes in the factory. This deviation may be less than (or less than or equal to) the threshold. Such a case may not warrant a further optimization analysis of the cleaning process, photolithographic process, etc. using ammonia. If the deviation is not greater than the threshold (block 310), method 300 completes.

If the deviation is greater than (or greater than or equal to) the threshold (block 310), processing logic can send a notification identifying the resource for further optimization analysis at block 312. For example, processing logic may determine that the actual usage rate of ammonia used in multiple processes (e.g., cleaning process, photolithographic process, CMP process, etc.) in the factory was significantly greater than the expected usage rate of ammonia to be used in multiple processes (e.g., cleaning process, photolithographic process, CMP process, etc.) in the factory. This deviation may be greater than (or greater than or equal to) the threshold. Such a case may warrant a further optimization analysis of the cleaning process, CMP process, and tools and systems using ammonia. A user can further analyze the processes, recipes, tool parameters, factory systems, etc. to optimize the use of ammonia in the factory such that the actual usage rate of ammonia (e.g., the amount of ammonia purchased for a process) is equal to or closer to the expected usage rate of ammonia. Identifying a significant deviation between the actual usage rate of a resource and the expected usage rate of the resource enables users to identify factory processes, tools, and systems that may be optimized for cost savings.

At block 312, in one embodiment, processing logic sends a notification to one or more client machines via a network identifying the factory process, tool, and/or system, using the resource, for further optimization analysis. For example, processing logic can send an alert, an email message and/or text message to one or more users accessible via one or more client machines (e.g., client machine 211 in FIG. 2). Examples of the data that can be included in a notification are the resource, the process using the resource, the tools and/or tool components using the resource, the process recipe parameters, the tool settings, the factory system using the resource, and resource optimization data.

FIG. 3B illustrates another embodiment of a method 350 for identifying resources for optimization. Method 350 can be performed by processing logic that can comprise hardware (e.g., circuitry, dedicated logic, programmable logic, microcode, etc.), software (e.g., instructions run on a processing device), or a combination thereof. In one embodiment, method 350 is performed by the resource optimization identification apparatus 201 of FIG. 2.

At block 352, processing logic receives factory data for each tool and/or factory system using a resource. If a resource is used by sub-factory system or a component of a tool, processing logic can collect data on resource usage for these sub-factory systems and components of the tools as well. Processing logic can track sensors on the tools to collect factory data to measure the usage of the resource. Processing logic can also track the sensors to determine the usage rate for a resource for specific recipes over time. Processing logic can receive data for a resource used in a single process, multiple processes or by multiple tools or systems. For example, the gas resource nitrogen trifluoride (NF3) can be consumed during the process of plasma etching silicon wafers by a process tool that has three chambers A, B, and C. Each chamber may run the same recipe using the gas NF3. Processing logic can track the sensors in each chamber to collect data for each of the chambers running the recipe consuming the gas NF3.

At block 354, processing logic determines the factory's expected usage rate for the resource. Processing logic can combine the sensor data collected from the manufacturing tools using the resource and the data collected from the factory systems using the resource to determine the factory's overall expected usage rate for the resource. At block 356, processing logic stores the collected factory data and the expected usage rate for a resource. Processing logic can store the data in a persistent storage unit (e.g., persistent storage unit 217 in FIG. 2). In one embodiment, the data can be stored in a common database.

At block 358, processing logic receives resource planning data for the factory resource. Processing logic can obtain the resource planning data for the resource from a resource planning system (e.g., an enterprise planning (ERP) system). For example, processing logic can obtain the amount of NF3 purchased for the factory.

At block 360, processing logic determines the factory's actual usage rate for the resource using the data obtained from the resource planning system. For example, processing logic calculates the actual usage rate for NF3 for the factory using the amount of NF3 purchased. At block 362, processing logic stores the resource planning data and the actual usage rate data. Processing logic can store the data in a persistent storage unit (e.g., persistent storage unit 217 in FIG. 2). In one embodiment, the data can be stored in a common database. In one embodiment, processing logic can correlate the stored data to yield management and factory and cycle time improvement.

In one embodiment, at block 364, processing logic generates and provides a GUI to illustrate a comparison of the expected usage rate to the actual usage rate. Processing logic can provide the GUI on a display device coupled to the processor (e.g., output device 233 in FIG. 2) according to one embodiment. In another embodiment, processing logic can generate GUIs and one or more client machines (e.g., client machines 211 in FIG. 2) can render the GUIs via a browser. In yet another embodiment, processing logic can provide data for the GUI to a client machine that will then generate a GUI.

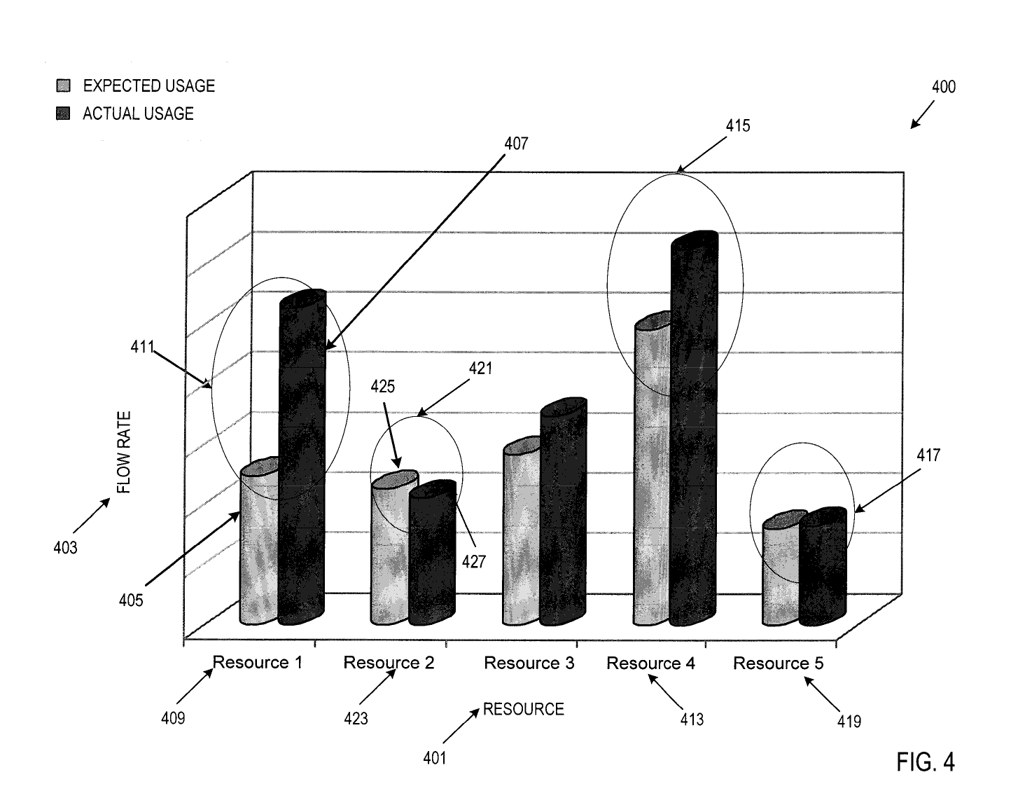

In one embodiment, processing logic provides a visual indicator in the GUI indicating a factory resource for optimization (block 366). FIG. 4, described in greater detail below, illustrates an exemplary GUI for identifying a factory resource that may warrant further optimization analysis. A GUI can illustrate a deviation between the factory's actual usage rage and the factory's expected usage rate for a resource. A user (e.g., an engineer) can perform further optimization analysis of the processes, tools, and/or systems consuming the resource based on the deviation identified in the GUI.

In one embodiment, at block 368, processing logic can provide a user interface to enable further optimization analysis of the processes, tools, and/or systems consuming a resource based on a deviation identified in the GUI at block 366. FIGS. 5A-C, described in greater detail below, illustrate exemplary GUIs to further enable optimization analysis of a resource.

In one embodiment, at block 370, processing logic can determine revised parameters to optimize the factory's consumption of a resource based on an optimization analysis. For example, processing logic can receive revised parameters as a user input. A user can determine how to optimize a factory's actual resource usage based on the optimization analysis enabled by the user interface provided at block 368. For example, a user may revise recipe parameters, idle settings on tools, and systems settings that use a particular resource. The revised parameters can set new targets for the resource usage. Thresholds (limits) can be established based on the revised parameters. A threshold is a test that determines whether the revised parameters are followed. The thresholds can be monitored on specific tools and systems.

In one embodiment, at block 372, processing logic can send instructions to factory processes, tools, and systems to optimize the consumption of the resource by the processes, tool, and systems. Examples of instructions include the revised recipe parameters, idle settings on tools, systems settings and associated monitors (e.g., thresholds being monitored).

FIG. 4 illustrates an exemplary GUI 400 to identify a factory resource for optimization, according to one embodiment of the invention. GUI 400 illustrates the consumption for a factory consuming various resources (e.g., chemicals, gases, precursor, water, energy, etc.). In this example, GUI 400 illustrates the consumption for a factory running various processes and systems that use Resources 1-5 (e.g., ammonia, sulfuric acid, stripper, peroxide, and hydrochloric acid). GUI 400 includes an x-axis 401 to represent resources and a y-axis 403 to represent a flow rate for each resource. GUI 400 illustrates a comparison of the expected usage rate (e.g., 405, 425) to the actual usage rate (e.g., 407, 427) for each resource (e.g., ammonia, sulfuric acid, stripper, peroxide, hydrochloric acid). GUI 400 can also include color to represent the expected usage rate and the actual usage for each resource. In other embodiments, a GUI may use other visual indicators (e.g., different patterns, different shading, different shapes, etc.) to represent the expected usage rate and the actual usage for each resource.

GUI 400 provides a visual indicator of a factory resource that warrants further optimization analysis. GUI 400 illustrates the deviation 411 between the factory's actual usage rate 407 of Resource 1 (409) and the factory's expected usage rate 411 of Resource 1 (409). The deviation 411 may be greater than a threshold such that a user may further analyze the processes, tools, and/or systems using Resource 1, the process recipes, the tool settings, etc. to determine how to optimize the use of Resource 1 and decrease the deviation. This would in turn reduce the expense in purchasing more than the expected amount of Resource 1 to be used. Similarly, GUI 400 illustrates a deviation 415 between the factory's actual usage rate and the factory's expected usage rate for the Resource 4 (413). The deviation 415 may be greater than a threshold warranting further resource optimization analysis. In another example, GUI 400 illustrates the deviation 417 between the factory's actual usage rate of Resource 5 (419) and the factory's expected usage rate of Resource 5 (419). The deviation 417 may not be greater than a threshold and thus, may not warrant further resource optimization analysis. In another example, GUI 400 illustrates the deviation 421 between the factory's actual usage rate 427 of Resource 2 (423) to the factory's expected usage rate 425 of Resource 2 (423). In this example, the factory's expected usage rate 425 of Resource 2 is greater than the factory's actual usage rate 427 of Resource 2. A graphical indication where the factory's expected usage rate is greater than the factory's actual usage rate may also warrant further analysis. Such a deviation may indicate that less of a consumable is being used than was expected. The deviation may identify a potential savings opportunity for a factory where the factory may be using less than the expected amount of resources and still produce a satisfactory product.

FIGS. 5A, 5B and 5C illustrate exemplary GUIs (500, 540, and 560) to further enable optimization analysis for a tool, system, or process using a resource, according to one embodiment of the invention. A user (e.g., an engineer) can use GUIs 500, 540 and 560 to further analyze the processes, tools, and/or systems consuming a resource and to determine revised parameters (e.g., recipe parameters, tool settings, system settings, etc.) than can optimize the consumption of a resource. GUI 500 illustrates the flow rate for a tool having three chambers running a process using the gas nitrogen trifluoride (NF3). In this example, GUI 500 includes an x-axis 501 to represent time and a y-axis 503 to represent flow rate. GUI 500 can include color to represent the data for each chamber 505. In other embodiments, a GUI may use other visual indicators (e.g., different patterns, different shading, different shapes, etc.) to represent the data for each tool component. GUI 500 illustrates data collected for three chambers A, B, and C, each running the same recipe using the gas NF3. GUI 500 shows chamber A 507 and chamber B 509 consuming NF3 for approximately four minutes and chamber C 511 consuming NF3 for approximately three minutes. GUI 500 provides a visual indicator of the difference in time 513 of chambers A and B running the recipe longer time than chamber C. The difference in time 513 is also a visual indicator of the costs savings in using the chemical resource NF3 if chambers A and B were optimized to perform at the standard defined by chamber C. A user may further analyze or modify the tool settings for chamber A and chamber B or review the process parameters to optimize the consumption of the chemical resource NF3 by chamber A and chamber B.

GUI 540 illustrates the flow rate for a tool having three chambers running a process using the gas nitrogen (N2). GUI 560 illustrates the flow rate for a tool having four chambers running a process using the gas helium.

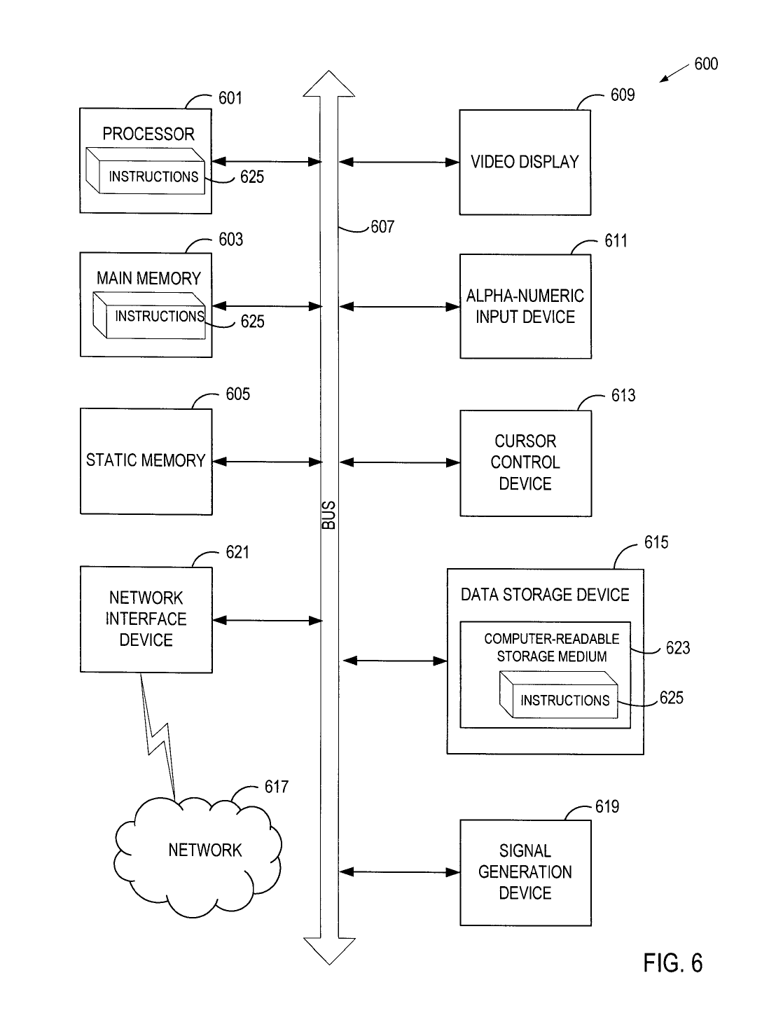

FIG. 6 illustrates a diagrammatic representation of a machine in the exemplary form of a computer system 600 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing device (processor) 601, a main memory 603 (e.g., read-only memory (ROM), flash memory, dynamic random access memory (DRAM) such as synchronous DRAM (SDRAM) or Rambus DRAM (RDRAM), etc.), a static memory 605 (e.g., flash memory, static random access memory (SRAM), etc.), and a data storage device 615 (e.g., drive unit), which communicate with each other via a bus 607.

The processor 601 represents one or more general-purpose processing devices such as a microprocessor, central processing unit, or the like. More particularly, the processor 601 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 601 may also be one or more special-purpose processing devices such as an application specific integrated circuit (ASIC), a field programmable gate array (FPGA), a digital signal processor (DSP), network processor, or the like. The processor 601 is configured to execute the instructions 625 for performing the operations and steps discussed herein.

The computer system 600 may further include a network interface device 621. The computer system 600 also may include a video display unit 609 (e.g., a liquid crystal display (LCD) or a cathode ray tube (CRT)), an alphanumeric input device 611 (e.g., a keyboard), a cursor control device 613 (e.g., a mouse), and a signal generation device 619 (e.g., a speaker).

The data storage device 615 may include a computer-readable storage medium 623 on which is stored one or more sets of instructions 625 (e.g., software) embodying any one or more of the methodologies or functions described herein. The instructions 625 may also reside, completely or at least partially, within the main memory 603 and/or within the processor 601 during execution thereof by the computer system 600, the main memory 603 and the processor 601 also constituting computer-readable storage media. The instructions 625 may further be transmitted or received over a network 617 via the network interface device 621.

The computer-readable storage medium 623 may also be used to store data structure sets that define user identifying states and user preferences that define user profiles. Data structure sets and user profiles may also be stored in other sections of computer system 600, such as static memory 605.

While the computer-readable storage medium 623 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories and optical and magnetic media.

It is to be understood that the above description is intended to be illustrative, and not restrictive. Many other embodiments will be apparent to those of skill in the art upon reading and understanding the above description.

What is claimed is:

1. A computer-implemented method comprising:
determining, by a server computer system, an expected usage rate for a resource in a manufacturing facility;
determining, by the server computer system, an actual usage rate for the resource in the manufacturing facility;
facilitating a comparison between the expected usage rate and the actual usage rate;
determining, based on the comparison, whether a variance between the expected usage rate and the actual usage rate exceeds a threshold; and
providing a notification if the variance exceeds the threshold.

2. The computer-implemented method of claim 1, wherein the expected usage rate is determined based on data collected from one or more processes, one or more tools, or one or more systems using the resource in the manufacturing facility.

3. The computer-implemented method of claim 1, wherein the actual usage rate is based on resource planning data for the resource.

4. The computer-implemented method of claim 1, wherein the threshold is any one of a user-defined threshold, a baseline, a benchmark, a user-defined limit, and a limit that is based on actual data that is collected over time.

5. The computer-implemented method of claim 1, further comprising:
providing a comparison of the expected usage rate and the actual usage rate to a client machine.

6. The computer-implemented method of claim 1, further comprising:
providing a visual indicator on a graphical user interface (GUI) indicating that the resource requires optimization analysis.

7. The computer-implemented method of claim 1, further comprising:
receiving one or more parameters optimizing the actual usage rate for the resource; and
sending instructions to the manufacturing facility based on the one or more parameters.

8. A computer-readable storage medium comprising executable instructions to cause a processor to perform operations, the instructions comprising:
determining, by a server computer system, an expected usage rate for a resource in a manufacturing facility;
determining, by the server computer system, an actual usage rate for the resource in the manufacturing facility;
facilitating a comparison between the expected usage rate and the actual usage rate;
determining, based on the comparison, whether a variance between the expected usage rate and the actual usage rate exceeds a threshold; and
providing a notification if the variance exceeds the threshold.

9. The computer-readable storage medium of claim 8, wherein the expected usage rate is determined based on data collected from one or more processes, one or more tools, or one or more systems using the resource in the manufacturing facility.

10. The computer-readable storage medium of claim 8, wherein the actual usage rate is based on resource planning data for the resource.

11. The computer-readable storage medium of claim 8, wherein the threshold is a user-defined threshold, a baseline, a benchmark, a user-defined limit, or a limit that is based on actual data that is collected over time.

12. The computer-readable storage medium of claim 8, wherein the instructions further comprise:
providing a comparison of the expected usage rate and the actual usage rate to a client machine.

13. The computer-readable storage medium of claim 8, wherein the instructions further comprise:
providing a visual indicator on a graphical user interface (GUI) indicating that the resource requires optimization analysis.

14. The computer-readable storage medium of claim 8, wherein the instructions further comprise:
receiving one or more parameters optimizing the actual usage rate for the resource; and
sending instructions to the manufacturing facility based on the one or more parameters.

15. A computer system comprising:
a memory; and
a processor configurable by instructions stored in the memory to:
determine an expected usage rate for a resource in a manufacturing facility;
determine an actual usage rate for the resource in the manufacturing facility;
facilitate a comparison between the expected usage rate and the actual usage rate;
determine, based on the comparison, whether a variance between the expected usage rate and the actual usage rate exceeds a threshold; and
provide a notification if the variance exceeds the threshold.

16. The computer system of claim 15, wherein the expected usage rate is determined based on data collected from one or more processes, one or more tools, or one or more systems using the resource in the manufacturing facility.

17. The computer system of claim 15, wherein the actual usage rate is based on resource planning data for the resource.

18. The computer system of claim 15, wherein the threshold is a user-defined threshold, a baseline, a benchmark, a user-defined limit, or a limit that is based on actual data that is collected over time.

19. The computer system of claim 15, wherein the processor is further configurable to:
provide a comparison of the expected usage rate and the actual usage rate to a client machine.

20. The computer system of claim 15, wherein the processor is further configurable to:
provide a visual indicator on a graphical user interface (GUI) indicating that the resource requires optimization analysis.

21. The computer system of claim 15, wherein the processor is further configurable to:
receive one or more parameters optimizing the actual usage rate for the resource; and
send instructions to the manufacturing facility based on the one or more parameters.
